(19) United States
(12) Patent Application Publication
(10) Pub. No.: US 2017/0359301 A1
(43) Pub. Date: Dec. 14, 2017

(54) CONTACT AND IDENTITY MANAGEMENT SYSTEM AND METHOD

(71) Applicant: Amna H. Shah, Chattanooga, TN (US)

(72) Inventor: Amna H. Shah, Chattanooga, TN (US)

(73) Assignee: HAFSAH, INC., Chattanooga, TN (US)

(21) Appl. No.: 15/178,793

(22) Filed: Jun. 10, 2016

(51) Int. Cl. H04L 29/12

(52) U.S. Cl. CPC H04L 61/1594

(57) ABSTRACT

A system for storing and exchanging contacts information uses a central server having a contacts database. At least one client device has at least one of its own contacts databases. The system includes at least one client interface. The contacts database from each of the at least one client device is linked to the central contacts data store and wherein client devices share contact information using exchanges of data with the central data store.

### BACKGROUND OF THE INVENTION

### 1. Field of the Invention

The field of the invention is a system for managing contact information independently of any one particular phone, device, communication account, or other traditional repository of contact information.

### 2. Background of the Invention

In various embodiments, the invention provides a device and system for sharing and storing contact information which is independent of any particular phone, another device, communication system, or any other source of contact information.

In one embodiment, the invention comprises a central server, at least one data store, and a user application such as a website or mobile application. The server provides the logic, while the data store provides a location for storing of contact information, with the user application providing a means to update the data store.

Traditionally, contact information has been stored with a particular application in a particular device. Further, contacts are often tied to a particular communications account, such as to a particular e-mail or social media account. In some prior art approaches, systems are provided to backup contacts from a device. However, the resulting backup is tied to a particular application and device type. Synchronization of contact information is difficult and sharing is only possible if a particular contact-using application supports such a feature.

A need exists in the art for a system that allows for synchronizing contact information across many devices, applications, which is agnostic to the user's current choice of technology.

### SUMMARY OF INVENTION

An object of the invention is to create a system for managing of contact information. An advantage of the invention is that it allows for storage and management of contact information in an independent service. An advantage of the invention is that it prevents loss of contact information.

Another object of the invention is to allow for exchange of contact information between users of incompatible devices. A feature of the invention is that devices having the contact management software may share synchronized contacts with one another. An advantage of the invention is that it maintains contact information independently of devices using the contact information.

A further object of the invention is to provide a system to maintain correct contact information for each entity in the system. A feature of the invention is that updates to contacts are sent to all devices sharing in the synchronized address book. An advantage of the invention is that it updates many disparate and physically distant address books with information from a centralized source when that centralized source is updated.

An object of the invention is to provide a means to backup contact information to an independent service. A feature of the invention is that the end-user application stores contact information within the application but also in a remote data store. An advantage of the invention is that the end user's contact information is not lost should the device be misplaced or stolen.

Yet another object of the invention is to provide a single account for the contact information for the lifetime of the user. A feature of the invention is that the user contact database is not tied to a particular email address, phone number, position, or other factor. An advantage of one embodiment is that it allows for a single database of contacts to be used for a user's lifetime.

A further object of the invention is to provide a system for informing users of changes to a registered entity. A feature of the invention is that third parties who are sharing contact information will be informed whenever a contact detail changes. A benefit of the system is that it allows end users to receive concise updates of changes to contact information such as when a user changes designation, job, contact details, or schools.

Another object of the invention is to provide a system for sharing of contact information. A feature of the invention is that the end user application generates a QR code which is used to share the contact details with third party user applications. A benefit of the system is that any device capable of reading a QR code can begin the process of exchanging information with a user of the invented system.

An additional object of the invention is to exchange contact information independently of any device. A feature of the invention is that the contact information may be accessed using a web interface and a web browser. A benefit of the system is that contact information is accessible not only on the device but also on a dedicated web portal.

A further object of the invention is to provide a system for centralized searching of contacts. A feature of the system is that in one embodiment the data store allows for searching of contacts from many programs and devices. A benefit of the system is that it allows for a global search of the end user's contacts regardless of the device used.

An additional object of the invention is to provide a system for preventing loss of contact information. A feature of the invention is that contact information is synchronized across many devices and a central data store and can be restored a device by downloading and installing an app. A benefit of the invention is that in some embodiments, the system prevents loss of contact details and other information.

A further object of the invention is to provide a system to share contact information on social media. A feature of the system is that the central server includes one or more interfaces to social media websites. A benefit of the system is that contact synchronization is initiated and shared via social media services.

An additional object of the invention is to allow users to group contacts when sending communications. A feature of the system is that the end user may define one or more groups which can be used to send group e-mail, messages, calls, and other communication tasks. A benefit of the system is that it allows for groups to be defined across many devices and applications.

A further object of the invention is to provide a means to rate contacts. A feature of the system is that for some contacts, a rating system is available, in some embodiments. A benefit of the system is that end users may share professional interactions involving businesses with other contacts using a rating system.

An additional object of the invention is to provide a mechanism for recommendations based on searches. A feature of the system is that the end user's search can include actual matches as well as suggested matches based on the user's needs. A benefit of the system is that end users' are exposed to potential new contacts, especially in the corporate or professional services field.

A system for exchanging contact information comprising a server having a central contacts data store; at least one client device having at least one contacts database; at least one client interface; wherein the contacts database from each of the at least one client device is linked to the central contacts data store and wherein client devices share contact information using exchanges of data with the central data store.

### BRIEF DESCRIPTION OF DRAWING

The invention together with the above and other objects and advantages will be best understood from the following detailed description of the preferred embodiment of the invention shown in the accompanying drawings, wherein:

FIG. 1 depicts an overview of the system pursuant to one embodiment of the invention;

FIG. 2 depicts an overview of an embodiment of the invention;

FIGS. 3A-D depicts an overview of an interface of the invention;

FIG. 4 depicts another view of an embodiment of an interface of the invention;

FIGS. 5A-B depicts alternative view of an embodiment of an interface of the invention;

FIGS. 6A-D depict views of several functions of an embodiment of the invention; and

FIG. 7 depicts a view of one embodiment of the data store of the invention.

### DETAILED DESCRIPTION OF THE INVENTION

The foregoing summary, as well as the following detailed description of certain embodiments of the present invention, will be better understood when read in conjunction with the appended drawings.

To the extent that the figures illustrate diagrams of the functional blocks of various embodiments, the functional blocks are not necessarily indicative of the division between hardware circuitry. Thus, for example, one or more of the functional blocks (e.g. processors or memories) may be implemented in a single piece of hardware (e.g. a general purpose signal processor or a block of random access memory, hard disk or the like). Similarly, the programs may be stand-alone programs, may be incorporated as subroutines in an operating system, may be functions in an installed software package, and the like. It should be understood that the various embodiments are not limited to the arrangements and instrumentality shown in the drawings.

As used herein, an element or step recited in the singular and proceeded with the word “a” or “an” should be understood as not excluding plural said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

### System Overview

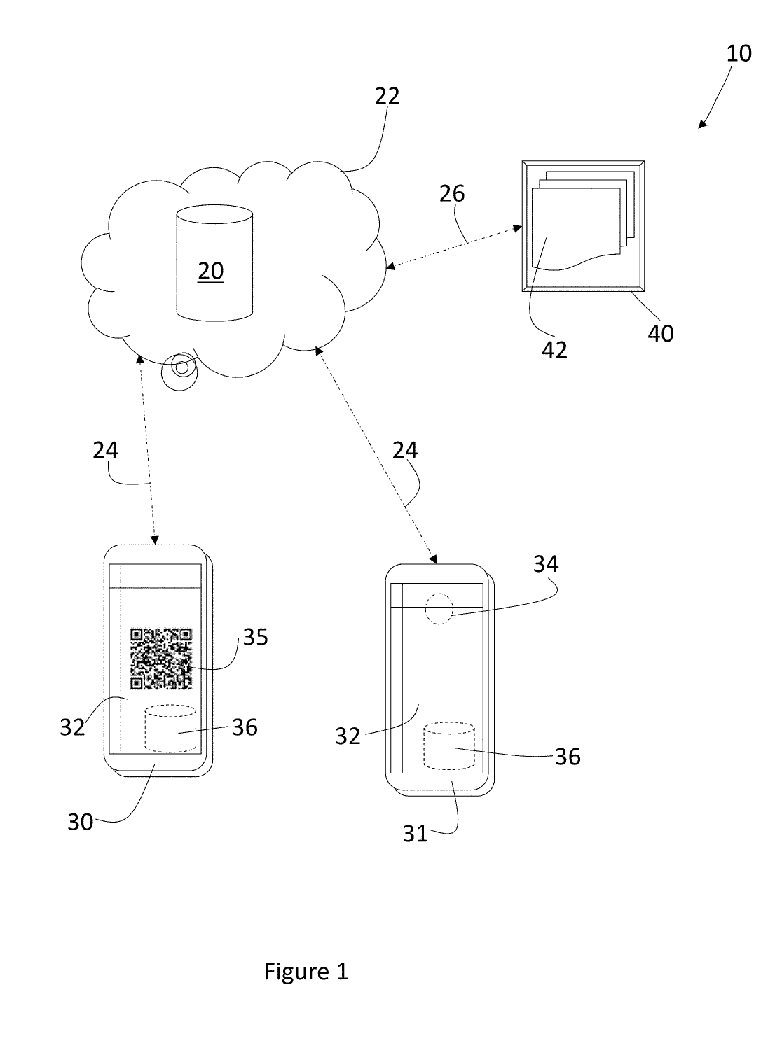

Turning to the figures, FIG. 1, depicted therein is an example implementation of the invented system 10. The primary components of the system include the central data store 20, a first mobile device 30, a second mobile device 31, and a secondary interface 40.

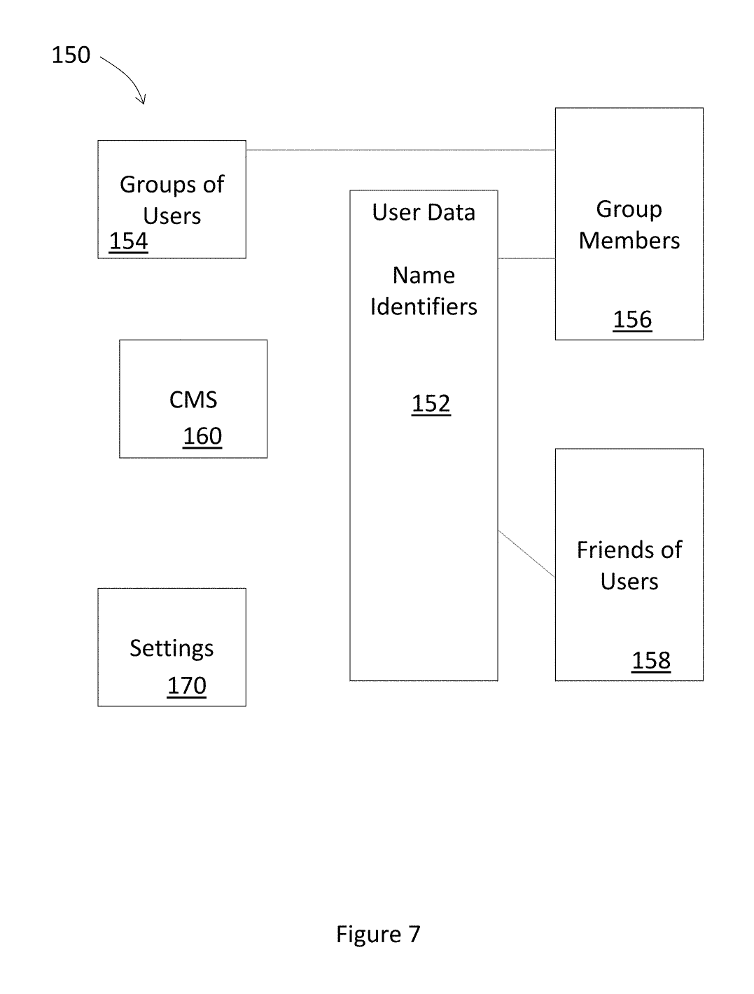

The data store 20 comprises contact information, in one embodiment. The data store 20 is implemented using a relational database, in one embodiment, the relational database engine is MySQL. The data store 20 is optimized for concurrent use and supports both read and write operations. The data store 20 includes contact information, system login information, and other metadata. The details of the data store 20 are discussed below in conjunction with FIG. 7, below.

The data store 20 is hosted on a single server, in one embodiment. As shown in FIG. 1, the data store 20 is hosted in a multi-server cloud environment 22, in another embodiment. In one such multi-server embodiment, the data store 20 is stored in a cloud-based database such as Azure by Microsoft. For clarity, the data store 20 is depicted as a single object, however, as implemented the data store 20 comprises several underlying databases so as to facilitate load balancing, ensure redundancy of information, and other features. The data store 20 comprises computer readable media hosted on a computing device, such as a server, a workstation, or combinations thereof. The server or workstation include a general-purpose operating system with added logic designed to support the system 10.

In one embodiment, the data store 20 comprises computer-readable media logically representing objects wherein each object comprises contact information.

As shown in FIG. 1, multiple client devices communicate with the data store 20 using a client communication link 24. In one embodiment, the client communication link 24 comprises web-based communication using TCP/IP data packets. In another embodiment, the client communication link 24 comprises a dedicated link to the data store 24 such as infrared or low distance Bluetooth. In one embodiment, the system employs an internet connection to exchange information.

For purposes of clarity, in FIG. 1, two client devices 30, 31 are depicted. However, the system 10 is designed for use by thousands or millions of client devices. Each client device 30, 31 is a depicted as a mobile device such as a phone or tablet. Each client device 30, 31 includes a client-side of the communication link 24, such as a WIFI or Bluetooth modem. Each client device 30, 31 comprises an input and output device. The client devices 30, 31 are depicted as having a touchscreen 32, which functions as both an input and output device. Each client device 30, 31 further comprises a local database 36 of contact information. As shown in FIG. 1, the contact information database 36 is hosted within each device 30, 31. While as shown in FIG. 1, the contact information database 36 is shown as a singular unit, for most client devices 30, 31 the contact information database 36 will comprise multiple data sets. For example, one data set will be used for a phone book on each client device 30, 31 and a second data set will be used in conjunction with a first social media service running on each client device 30, 31.

As shown in FIG. 1, the first client device 30 display 32 is showing a QR code 35. The QR code 35 can be read by the second device 31 by using the second device 31 camera 34 which is found on the reverse side of the second device 31, and so the camera 34 is depicted in broken lines. The QR code is generated by the software running on the first client device 30, described more fully below. In another embodiment, instead of displaying a QR code 35, the first client device 30 sends human and computer readable code (such as a web link) to exchange the information.

In the invented system 10, the QR code 35 shown in FIG. 1 allows the first device 30 to exchange contact information and to link the contact information of the first device 30 to the second device 31. At the time the QR code 35 is shown, the first device 30 user can select which contact or contacts from the first device 30 contact information database 36 will be shared with the second device 31 and its contact information database 36.

Software running on both devices 30, 31 (described fully below) allows the contact information to be both shared and dynamically linked so that the entries from the contact information database 36 are updated in the second device 31 upon their change in the first device 30.

In the embodiment shown in FIG. 1, the client devices 30, 31 do not communicate directly to perform the contacts information database 36 synchronization, except when the devices first establish the dynamic link between the two devices through reading of the QR code 35. Instead, the client devices 30, 31 communicate with one another by exchanging data with the central data store 20 through the client link 24. In another embodiment, the client devices 30, 31 detect that they are on the same local network and exchange information with one another directly, especially when the amount of information to be exchanged is expected to exceed a data limit imposed by the end user of either device 30, 31. In one embodiment, the application interfaces with an end user device 30, 31 data use api to ensure that the end user is not nearing their data limit prior to undertaking a large synchronization. In another embodiment, the system confirms that the end user is not making active use of the device and instead performs the synchronization as a background task. Finally, in another embodiment, the system undertakes a synchronization task only while certain battery and network connectivity conditions are set. In one embodiment, the synchronization occurs only while battery life exceeds a preset value and a strong wifi connection is available.

The system 10 also comprises a secondary interface 40, which communicates with the central data store 20 using the secondary communications link 26. In one embodiment, the secondary interface 40 comprises a series of web-pages 42 which allow an end user to communicate with the system on a larger screen, view records, and undertake account management tasks. The series of web pages 42 depict information such as the total number of shared contacts, which client applications are sharing the data, and other information about the end-user's account.

The secondary interface 40 also allows for a centralized search of all the end user's contacts through one interface, in one embodiment. The secondary interface 40 is also used to perform batch updates and large amounts of data entry that would be difficult to perform on an end user device 30, 31.

### Client Software

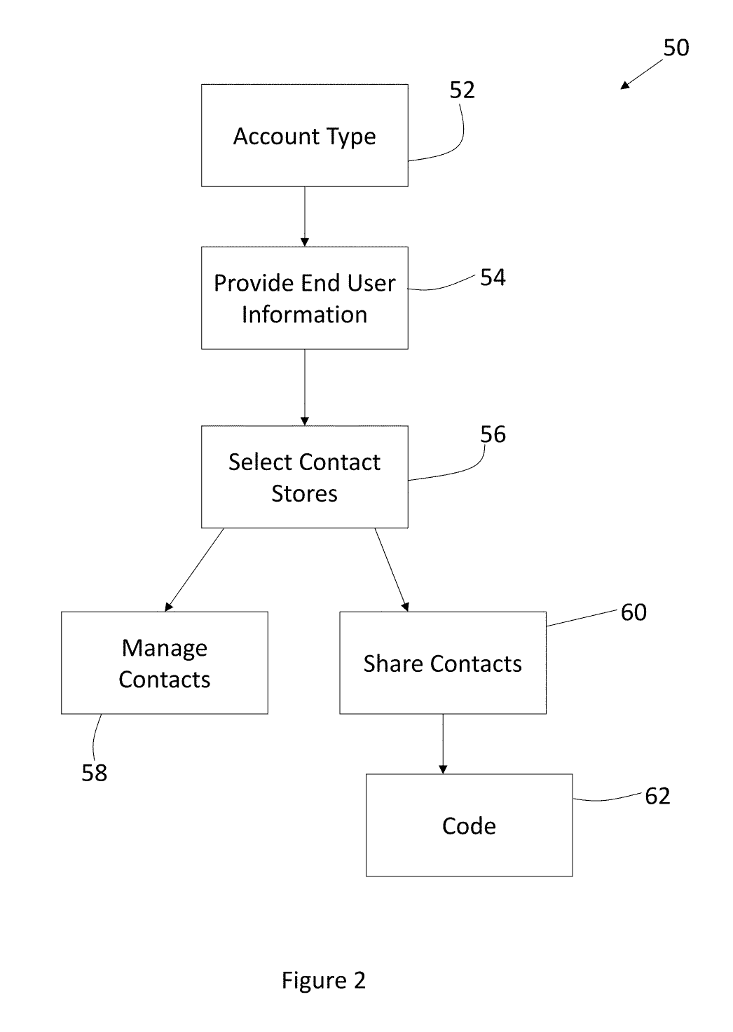

Turning to FIG. 2, depicted therein is an overview of the software 50 running on the client devices 30, 31.

As shown in FIG. 2, the software 50 initiates a new user with the signup process 52. The end user can select an account type, either a personal or corporate. In one embodiment, a corporate account can include more than one personal accounts within the logical structure of the corporate account. As depicted in subsequent figures, the signup process for corporate accounts versus personal accounts requires different types of information. In regards to the two types of accounts, sign up data different: for corporate accounts, there is no full name, contact person name, and in some embodiments the end user employee cannot upload a picture. Instead, the account includes just the corporate logo, and contact person name, along with corporate phone number. Otherwise the card looks the same. The system allows the corporate user to save on business card expenses.

In this manner, a corporate account is created with all the employees being sub-units of that account.

Once the type of account is established, the end user proceeds to the step of providing end user information 54. The end user information 54 includes contact information such as phone number, e-mail address, social media information, and other types of information.

Subsequently, the software 50 selects which local contact stores 56 to synchronize with. By default, the software 50 populates the end user's account with the client device 30 built-in address book. In another embodiment, the software 50 also establishes a link to other contact data stores such as social media accounts and secondary communications software, such as Skype and the like. In one embodiment, the user's data is retrieved from a pre-existing user's account. In another embodiment, several entries regarding the user are pre-populated and are immutable, such as a user setting up a work account wherein such an employed user cannot change the company's logo or mailing address.

One of the features of the software 50 is that the contact store interaction 56 is not a one-time occurrence. The software 50 establishes dynamic links with all the contact stores such that changes to the contact store will be reflected in the software 50 and vice versa.

In one embodiment, the connection between each contact and the database of the software 50 is established by calculating checksums of each contact entry. The software determines when each has changed and when an update should be triggered. The system detects that an update has occurred when an end-user has triggered the edit option within the system. In one embodiment, the software comprises at least one prompt to ask the end user which contact is correct or most up to date. In another embodiment, the software 50 stores multiple versions of each contact, and assigns a value to each contact reflecting a level of certainty whether each contact contains the most current information.

Once the software 50 connection to the various contact stores 56 is established the end user manages contacts 58 through the software 50. The end user can edit their profile or any contact information. Once a change is made within the software 50 the change is sent into the central data store 20. The change is thereafter synchronized to third parties and it is backed up to the central data store 20, in the event of the corruption of the software 50 or loss of device 30, 31. In one embodiment, the resulting

Other than managing contacts 58, the end user may also share one or more contacts 60. As shown in FIG. 1, one sharing method is to provide a second client device 31 with a QR code 35 on the end user's first device 30. Another sharing method is to provide the user of the second device 31 with a link to the first device 30 user's account. Another sharing method is to post a specially-designed uniform resource identifier (such as a web address or another address readable by the software 50).

As shown if FIG. 2, the software 50 allows for the generation of a special code 62. In one embodiment, the special code is an alphanumerical code which is manually entered by an end user of the software 50. In another embodiment, the code is a QR code readable by one or more client devices 30, 31.

### Signup Process

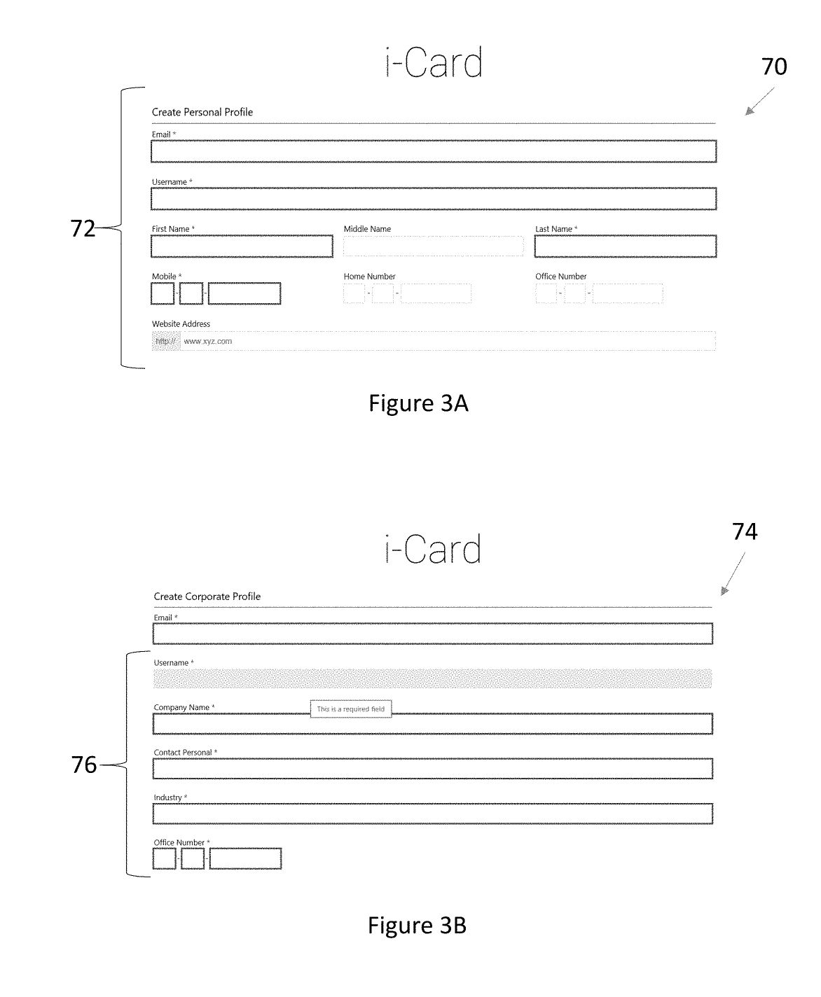

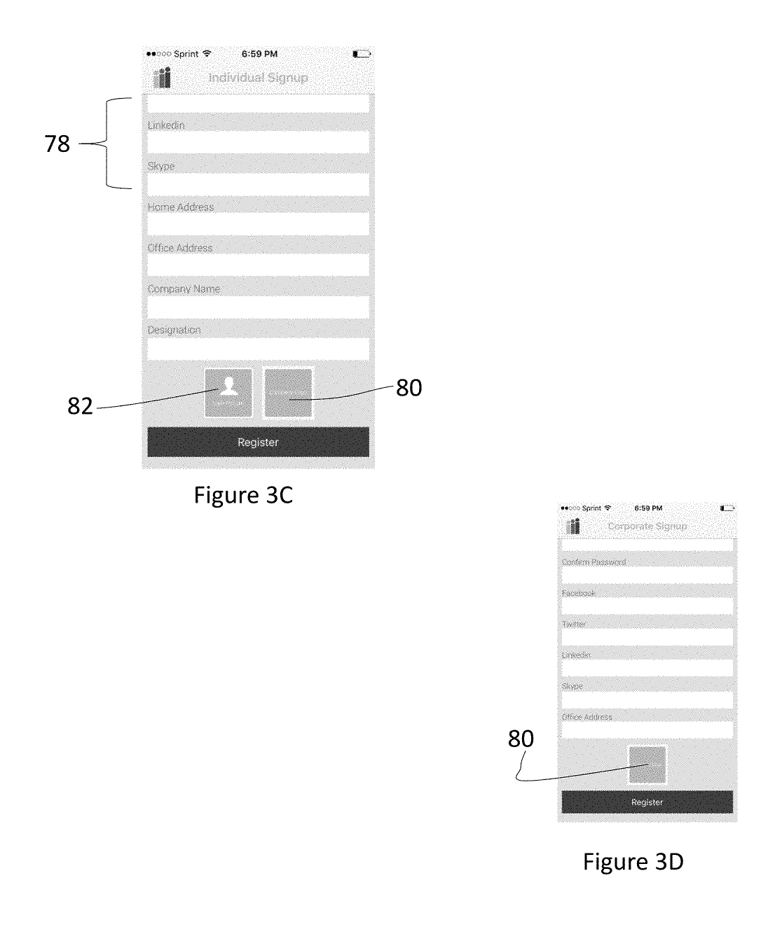

As shown in FIGS. 3A-3C, depicted therein are several screens of the sign up process for the software 50.

As shown in FIG. 3A, the personal 70 sign up process requires provision of customary personal identification information 72. The corporate sign up 74 process shown in FIG. 3B requires additional business information 76.

As shown in FIG. 3B, for corporate accounts the end user may not create a manual user name.

The sign up process includes the provision of several social media account information 78. The end user may also associate a personal photograph 82 and a corporate logo 80 with the end user's account. In one embodiment, the corporate logo 80 includes an association with a web address, such that the record allows for the end user to share the company address.

For corporate enrollment, shown in FIG. 3D, the end user photograph is eliminated, in one embodiment. Also, depending on the end user's position with the company, the corporate logo 80 and associated address may be a read-only entry.

### Main Interface

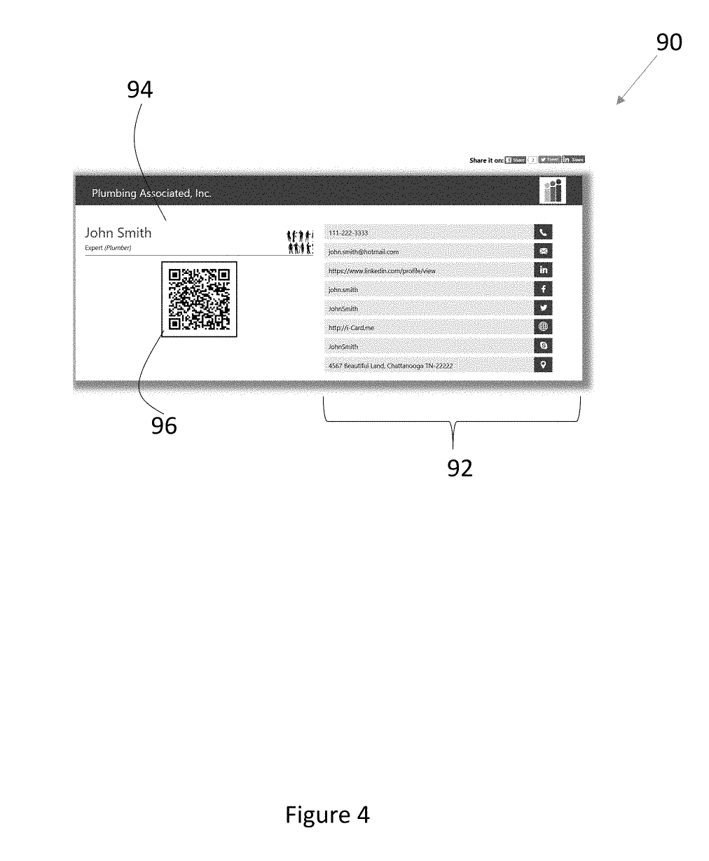

The main interface 90 of the software is shown in FIG. 4. The main interface comprises contact details 92 for each contact. In one embodiment, the contact details 92 comprises phone number, e-mail, web address, and social media accounts (such as LinkedIn, Facebook, Twitter, and others).

The main interface 90 also shows the contact name and company name 94. Finally, the main interface 90 includes a computer readable symbol, such as the QR code 96 shown in FIG. 4.

As part of the main interface, the system allows for providing recommendations and ratings of contacts. The information shown in the main interface 90 is up to date and synchronized with the central data store 20. The main interface acts an electronic business card, which can be shared by having the second device read the bar code 96.

The main interface 90 allows for searching of the contact directory, to create a group for communications purposes. The information shown in the main interface 90 is backed up to the data store 20.

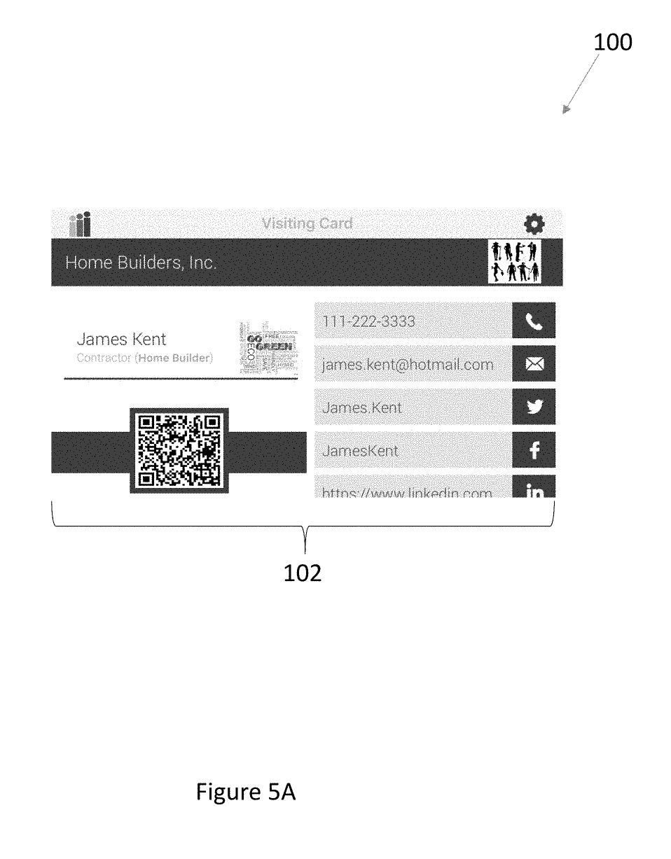

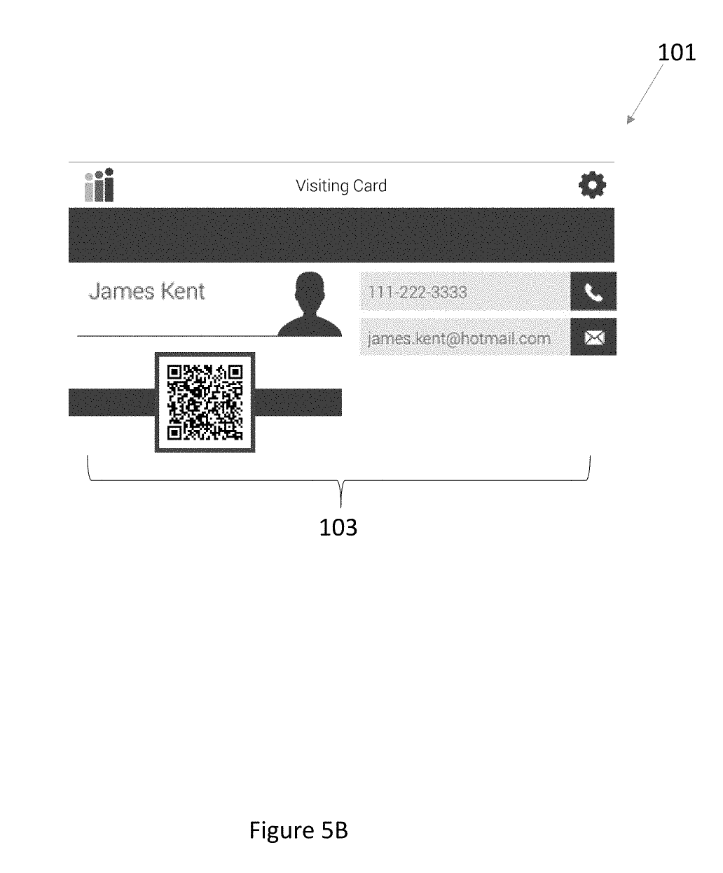

The sharing of a contact is depicted in FIG. 5A. The visiting business card 100 includes the visiting business contact information 102. The end user may accept or reject the visiting business card.

As shown in FIG. 5B, the same user may define more than one business card views. For example, as shown in FIG. 5B, the personal business card 101 contains some, but not all, personal contact information 103 as the business contact information 102. The end user can associate a different visiting card view and share different visiting cards depending on the context of the interaction (i.e. whether the context is personal versus professional).

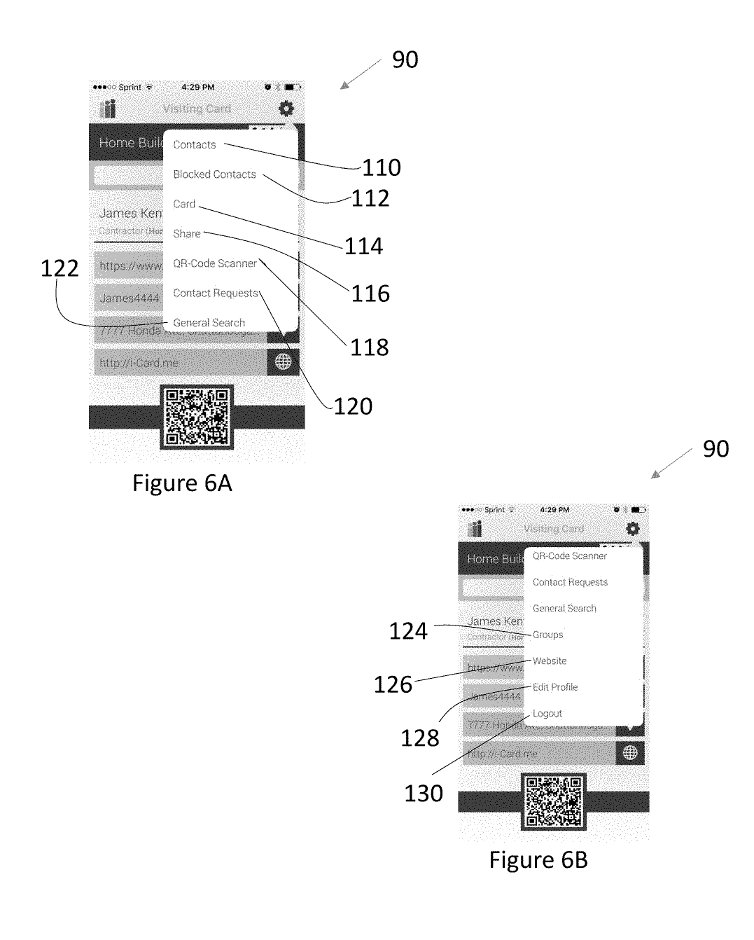

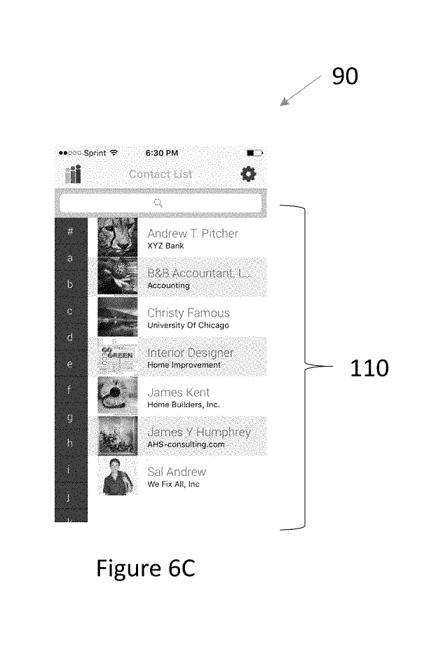

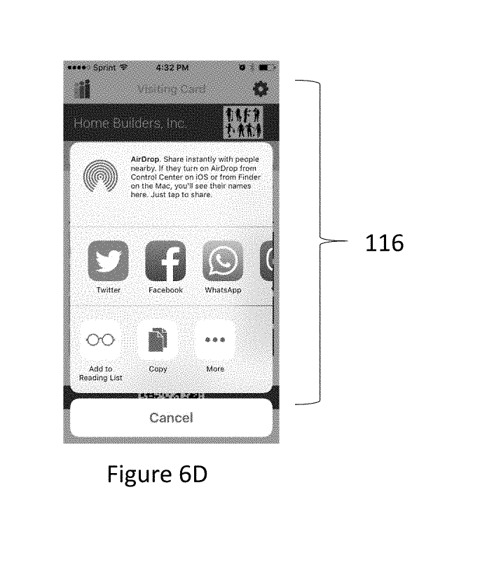

Additional functions of the software are depicted in FIGS. 6A-6C. As shown in FIG. 6A, the main interface 90 allows for the listing of all contacts 110. Further, the end user has complete control over the contacts list. As such, the end user may block 112 one or more contacts within the main interface 90. The end user may also view their own business card 114 to preview how it appears to third parties.

Additionally, the end user may invoke one or more share 116 functions. The share 116 functions allow the end user to provide a link to the software to one or more social media contacts, share the end user's contacts, and other functions.

Further, the end user may open the QR code scanner 118, review contact requests 120, and perform a search 122. The end user may define groups 124, visit the website 126, and edit their profile 128. The user may also log out of the account 130, as would be necessary if the end user was accessing the software interface 90 through the secondary access means 40.

In one embodiment, the QR scanner function 118 is invoked whenever a QR code associated with the client application is encountered.

The contacts list 110 is depicted in FIG. 6C, while sharing of the contacts information (through a means other than a QR code) is shown in FIG. 6D.

### Data Store Details

As shown in FIG. 7, the data store 20 contains a number of sets of data, implemented as database tables in the embodiment 150 depicted in FIG. 7. The data store embodiment 150 comprises a user data table 152 which includes user identifying information, such as name, address, and the machine readable qr code. In one embodiment, the graphical elements, such as the user's company logo are stored as a binary data within the database itself. In another embodiment, the graphical elements are stored as files linked to the database.

In one embodiment, the user data table 152 includes information used for two-factor authentication, such as an additional security token beyond the user's password. In some embodiments, the two-factor authentication is only used for some types of actions within the system, such as an update that would be instantly synchronized with other users. In another embodiment, removing data from the system requires two factor authentication. Inasmuch as in one embodiment, the primary user of the data store 150 is a mobile device user, the end user has access to two-factor authentication through means such as a secure third-party application or a text message based system.

In one embodiment, each user's type of address is stored as a single entry. For example, each user can only have one home address and one work address. In another embodiment, each user has multiple versions of data associated with each field, such as having multiple home addresses or multiple phone numbers.

Groups of users are defined in the groups of users data set 154 to allow users to associate. Inasmuch as many users may participate in many groups, a linking data set for group members 156 is also defined. In this way, each system participant in the user data table 152 can be associated with many groups 154. Groups include industries, co-workers, and informal groupings. In one embodiment groups include professional groups, such as business contacts, as well as personal groups, such as people invited to a particular event.

Users within the system may also indicate affinity for other users in the system by designating which users are ‘friends’ in the friendship data store 158.

Finally, the data store embodiment 150 includes a designated settings 170 and CMS 160 data stores. CMS data store 160 includes details about the user's account with the system, while the settings data store 160 defines each users' preferences within the system.

In summary, the proposed system allows a corporation to issue to its employees dynamic contact information access, which will be updated whenever a change occurs. For individuals, the system allows for single enrollment and exchange of contact information. The individual can readily give out contact information without worrying about it being out of date. Any changes to the contact information will be synchronized automatically and everywhere the end user has shared their contact information.

The system allows for resynchronization of contacts information in the event of a loss of a device. It removes the hassles of printing and maintaining business cards.

Although exemplary implementations of the invention have been depicted and described in detail herein, it will be apparent to those skilled in the relevant art that various modifications, additions, substitutions, and the like can be made without departing from the spirit of the invention and these are therefore considered to be within the scope of the invention as defined in the following claims.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. While the dimensions and types of materials described herein are intended to define the parameters of the invention, they are by no means limiting, but are instead exemplary embodiments. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the terms “comprising” and “wherein.” Moreover, in the following claims, the terms “first,” “second,” and “third,” are used merely as labels, and are not intended to impose numerical requirements on their objects. Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure.

The embodiment of the invention in which an exclusive property or privilege is claimed is defined as follows:

1. A system for storing and exchanging contacts information comprising:
a server having a central contacts data store;
at least one client device having at least one contacts database;
at least one client interface;
wherein the contacts database from each of the at least one client device is linked to the central contacts data store and wherein client devices share contact information using exchanges of data with the central data store.

2. The system of claim 1 wherein said client device comprises a cellular phone and said contacts database comprises a phone book.

3. The system of claim 1 wherein said data store is created for each user of the system regardless of the device used by the end user.

4. The system of claim 1 wherein said server pushes updates to each client device once a record within the central data store is updated.

5. The system of claim 4 wherein said updates comprise notification of change to at least one contact in a local device data store.
